(19) United States
(12) Patent Application Publication
(10) Pub. No.: US 2021/0200232 A1
(43) Pub. Date: Jul. 1, 2021

(54) METHOD OF GENERATING SCAN PATH OF AUTONOMOUS MOBILE ROBOT AND COMPUTING DEVICE

(71) Applicant: Polaris3D Co., Ltd., Gyeongsangbuk-do (KR)

(72) Inventors: In Veom KWAK, Gyeongsangbuk-do (KR); Ho Yong LEE, Gyeongsangbuk-do (KR); Chi Won SUNG, Gyeongsangbuk-do (KR)

(21) Appl. No.: 16/850,347

(22) Filed: Apr. 16, 2020

(30) Foreign Application Priority Data
Dec. 26, 2019 (KR) 10-2019-0175182
Feb. 26, 2020 (KR) 10-2020-0023799

(51) Int. Cl. G05D 1/02; G06T 5/00; G06T 7/13

(52) U.S. Cl. CPC G05D 1/0238; G05D 1/0251; G06T 7/13; G06T 5/002; G05D 1/0274

(57) ABSTRACT

A method is performed by a computing device including one or more processors and a memory that stores one or more programs executed by the one or more processors and includes acquiring a three-dimensional (3D) map of an interior, generating an occupancy height map by stacking spatial value histograms in a height direction while projecting the 3D map of the interior on a two-dimensional (2D) plane, and removing noise caused by a mobile object which moves in the interior from the occupancy height map.

### CROSS-REFERENCE TO RELATED APPLICATION

This application claims priority to and the benefit of Korean Patent Application Nos. 10-2019-0175182 filed on Dec. 26, 2019 and 10-2020-0023799 filed on Feb. 26, 2020, the disclosure of which is incorporated herein by reference in its entirety.

### BACKGROUND

### Field

Embodiments of the present disclosure relate to a scan path generation technology.

### 2. DISCUSSION OF RELATED ART

Recently, self-driving technology is being developed and applied to travel of a vehicle, robot, or the like. In a large supermarket, objects on racks are analyzed through autonomous driving of a robot. According to the related art, it is necessary to manually set a travel path (a scan path) of a robot, which is inconvenient.

### SUMMARY

Embodiments of the present disclosure are intended to provide a new technique for generating a scan path of an autonomous mobile robot indoors.

According to an aspect of the present disclosure, there is a method of generating a scan path of an autonomous mobile robot. The method is performed by a computing device including one or more processors and a memory that stores one or more programs executed by the one or more processors and includes acquiring a three-dimensional (3D) map of an interior, generating an occupancy height map by stacking spatial value histograms in a height direction while projecting the 3D map of the interior on a two-dimensional (2D) plane, and removing noise, which is caused by a mobile object moving in the interior, from the occupancy height map.

The generating of the occupancy height map may include converting the 3D map of the interior into a 2D map by projecting the 3D map on the 2D plane and detecting an area including spatial value data at a preset ratio in the 2D map as a valid data area.

The 3D map of the interior may be generated by the autonomous mobile robot scanning the interior while travelling in the interior, and the removing of the noise caused by the mobile object may include acquiring data of a travel path and a scanning path of the autonomous mobile robot in the interior, setting a part of the occupancy height map corresponding to the travel path of the autonomous mobile robot as a travelable area, and removing the noise caused by the mobile object by using the scanning path in the travelable area of the occupancy height map.

In the interior, a plurality of racks may be installed, and the removing of the noise caused by the mobile object may include detecting edges in the occupancy height map and removing noise from a part of the scanning path extending to the edges of the racks in the occupancy height map without removing noise from a part of the scanning path crossing the edges of the racks.

The method may further include, after the removing of the noise caused by the mobile object, removing remaining noise from the occupancy height map.

The method may further include detecting a grade of the occupancy height map and correcting a tilt of the occupancy height map by rotating the occupancy height map by the detected grade.

In the interior a plurality of racks may be installed, and the method may further include, after the removing of the noise caused by the mobile object, setting a surrounding scan path for each of the racks in the occupancy height map.

The setting of the surrounding scan path may include detecting each of the racks in the occupancy height map and setting a rack area including each of the detected racks and setting the surrounding scan path for each of the racks by expanding the rack area on the basis of a distance between the autonomous mobile robot and each of the racks.

The method may further include, after the setting of the surrounding scan path, generating a sequential scan path for scanning each of the racks in the occupancy height map.

According to another aspect of the present disclosure, there is a computing device including one or more processors, a memory, and one or more programs, stored in the memory and executed by the one or more processors, the one or more programs including: an instruction for acquiring a 3D map of an interior, an instruction for generating an occupancy height map by stacking spatial value histograms in a height direction while projecting the 3D map of the interior on a 2D plane, and an instruction for removing noise caused by a mobile object which moves in the interior from the occupancy height map.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram illustrating an example of a computing environment including a computing device appropriate for use in exemplary embodiments of the present disclosure;

FIG. 2 is a flowchart illustrating a method of generating a scan path of an autonomous mobile robot according to an embodiment of the present disclosure;

FIG. 3 is a two-dimensional (2D) map obtained by projecting a three-dimensional (3D) indoor map of a large supermarket on a 2D XY plane according to an embodiment of the present disclosure;

FIGS. 4A and 4B are histograms showing the distribution of spatial values in an X-axis and a Y-axis according to an embodiment of the present disclosure;

FIG. 5 is an occupancy height map according to an embodiment of the present disclosure;

FIG. 6 is an edge map generated by applying a filter to the occupancy height map according to an embodiment of the present disclosure;

FIG. 7 is a view showing a case in which an autonomous mobile robot scans a rack according to an embodiment of the present disclosure;

FIG. 8 is a view showing a case of removing noise from a part corresponding to a scanning path according to an embodiment of the present disclosure;

FIG. 9 is a view showing a case of removing noise from a part of a scanning path extending to an edge of a rack using an edge map without removing noise from a part of the scanning path crossing the edge of the rack according to an embodiment of the present disclosure;

FIGS. 10A and 10B are views showing an occupancy height map from which remaining noise is removed according to an embodiment of the present disclosure;

FIGS. 11A and 11B are views showing an occupancy height map whose tilt is corrected according to an embodiment of the present disclosure;

FIG. 12 is a view showing an occupancy height map in which a surrounding scan path is generated for each rack according to an embodiment of the present disclosure;

FIG. 13 is a view showing an occupancy height map in which a sequential scan path for each rack is generated according to an embodiment of the present disclosure; and

FIG. 14 is a view showing a computer-aided design (CAD) map generated from to the occupancy height map according to an embodiment of the present disclosure.

### DETAILED DESCRIPTION OF EXEMPLARY EMBODIMENTS

Hereinafter, embodiments of the present disclosure will be described in detail with reference to the accompanying drawings. The following detailed description is provided to assist the reader in gaining a comprehensive understanding of the methods, apparatuses, and/or systems described herein. However, the description is only exemplary, and the present disclosure is not limited thereto.

In describing the embodiments of the present disclosure, when it is determined that a detailed description of known techniques associated with the present disclosure would unnecessarily obscure the subject matter of the present disclosure, the detailed description thereof will be omitted. Also, terms used herein are defined in consideration of the functions in the present disclosure and may be changed depending on a user, the intent of an operator, or a custom. Accordingly, the terms should be defined based on the following overall description of this specification. The terminology used herein is only for the purpose of describing the embodiments of the present disclosure and is not restrictive. The singular forms “a,” “an,” and “the” are intended to include the plural forms as well unless the context clearly indicates otherwise. It should be understood that the terms “comprises,” “comprising,” “includes,” and/or “including,” specify the presence of stated features, integers, steps, operations, elements, and/or parts or combinations thereof when used herein, but do not preclude the presence or addition of one or more other features, integers, steps, operations, elements, and/or parts or combinations thereof.

Meanwhile, directional terms, such as an upper portion, a lower portion, one side, and the other side, are used in relation to orientation of the disclosed drawings. Since elements according to the embodiments of the present disclosure may be positioned with various orientations, the directional terms are used for illustrative purpose rather than to limit.

The terms, such as first and second, may be used to describe various elements, but the elements should not be limited to the terms. The terms may be used for the purpose of distinguishing one element from another element. For example, a first element may be termed a second element, and similarly, a second element may be termed a first element without departing from the scope of the present disclosure.

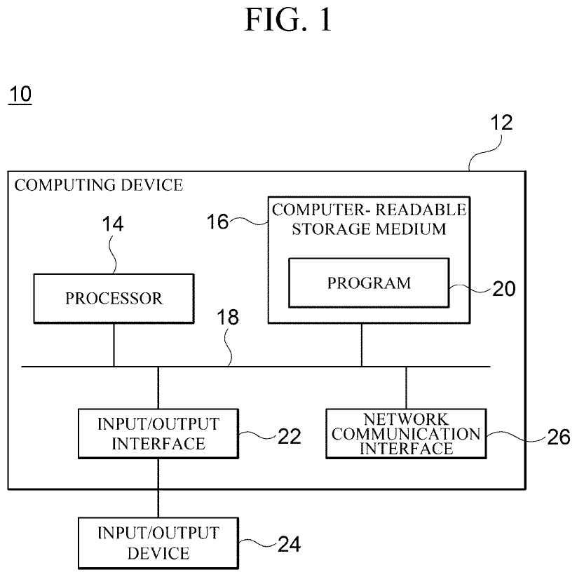

FIG. 1 is a block diagram illustrating an example of a computing environment 10 including a computing device appropriate for use in exemplary embodiments. In the shown embodiment, each component may have functions and capabilities other than those described below, and additional components other than those described below may be included.

The shown computing environment 10 includes a computing device 12. In an embodiment, the computing device 12 may be a device for generating a scan path of an autonomous mobile robot according to an embodiment of the present disclosure.

The computing device 12 may include at least one processor 14, a computer-readable storage medium 16, and a communication bus 18. The processor 14 may cause the computing device 12 to operate according to exemplary embodiments which will be described below. For example, the processor 14 may execute one or more programs stored in the computer-readable storage medium 16. The one or more programs may include one or more computer-executable instructions, which may be formed to cause, when executed by the processor 14, the computing device 12 to perform operations according to the exemplary embodiments.

The computer-readable storage medium 16 is formed to store computer-executable instructions, program codes, program data, and/or other suitable forms of information. Programs 20 stored in the computer-readable storage medium 16 include a set of instructions executable by the processor 14. In an embodiment, the computer-readable storage medium 16 may be a memory (a volatile memory, such as a random access memory, a non-volatile memory, or a suitable combination thereof), one or more magnetic disk storage devices, optical disk storage devices, flash memory devices, other forms of storage media accessible by the computing device 12 and capable of storing desired information, or suitable combinations thereof.

The communication bus 18 interconnects various components of the computing device 12 including the processor 14 and the computer-readable storage medium 16.

The computing device 12 may also include at least one input/output interface 22 which provides an interface for at least one input/output device 24 and at least one network communication interface 26. The input/output interface 22 and the network communication interface 26 are connected to the communication bus 18. The input/output device 24 may be connected to other components of the computing device 12 through the input/output interface 22. The exemplary input/output device 24 may include input devices, such as a pointing device (a mouse, a trackpad, or the like), a keyboard, a touch input device (a touch pad, a touch screen, or the like), a voice or sound input device, various types of sensor devices, and/or an imaging device, and/or output devices, such as a display device, a printer, a speaker, and/or a network card. The exemplary input/output device 24 may be included in the computing device 12 as a component constituting the computing device 12 or may be connected to the computing device 12 as a separate device distinct from the computing device 12.

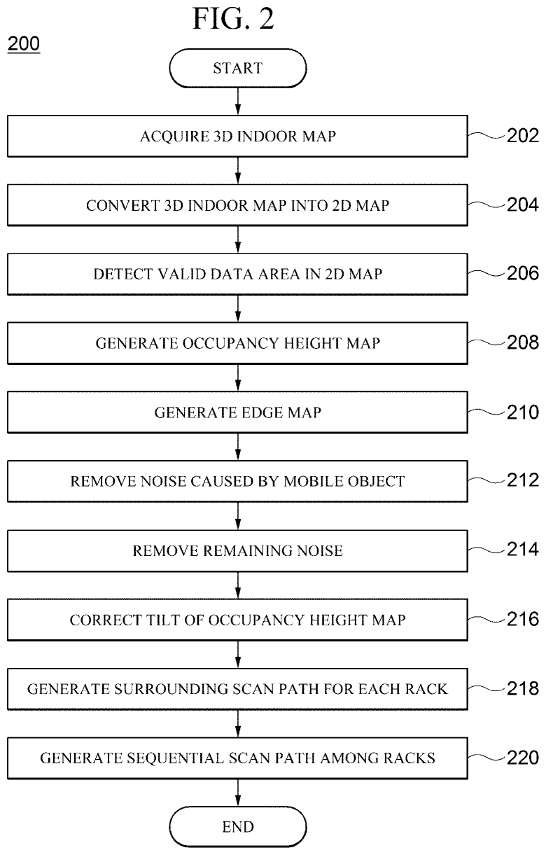

FIG. 2 is a flowchart illustrating a method of generating a scan path of an autonomous mobile robot according to an embodiment of the present disclosure. As described above, a method 200 according to the embodiment of the present disclosure may be performed by the computing device 12 including one or more processors and a memory for storing one or more programs executed by the one or more processors. To this end, the method 200 may be implemented in the form of a program or software including one or more computer-executable instructions and stored in the memory.

In the flowchart, the method 200 is illustrated as a plurality of operations. However, at least some operations may be performed in another sequence, performed in combination with another operation, omitted, or subdivided and performed, or one or more operations not shown in the drawing may be added and performed.

In operation 202, the computing device 12 acquires a three-dimensional (3D) map of an interior. In an exemplary embodiment, the interior may be a large indoor supermarket including a plurality of racks, but is not limited thereto. For convenience of description, it is assumed below that the interior is a large indoor supermarket. For example, a 3D indoor map of a large supermarket may be generated by an autonomous mobile robot scanning the interior while travelling in the large indoor supermarket, but the 3D indoor map is not limited thereto.

In operation 204, the computing device 12 converts the 3D indoor map into a two-dimensional (2D) map. In an exemplary embodiment, the computing device 12 may convert the 3D indoor map into a 2D map by projecting the 3D indoor map (e.g., a 3D indoor map of a large supermarket) on a 2D XY plane.

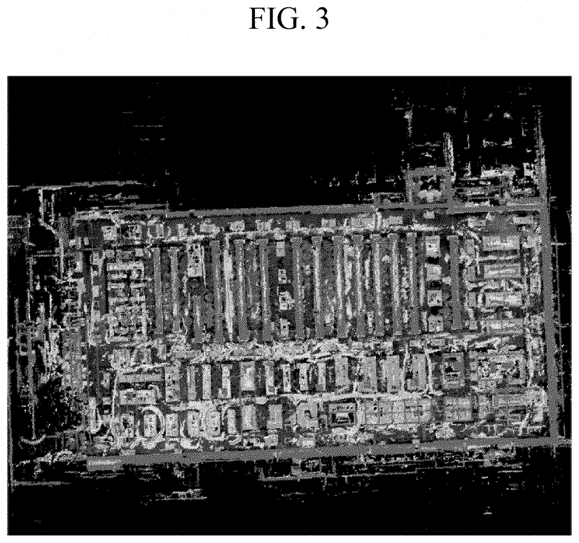

FIG. 3 is a 2D map obtained by projecting a 3D indoor map of a large supermarket on a 2D XY plane according to an embodiment of the present disclosure. Referring to FIG. 3, a blue part corresponds to a floor of the interior, and red parts correspond to a ceiling of the interior. Also, yellow parts are noise caused by mobile objects which move around the interior (e.g., people and animals) when the 3D map is to generated (i.e., while the autonomous mobile robot scans the interior). Embodiments of the present disclosure may be technically characterized by removing noise caused by a mobile object from an indoor map.

In operation 206, the computing device 12 detects a valid data area in the 2D indoor map. In an exemplary embodiment, the computing device 12 may perform histogram analysis with respect to an X-axis (the horizontal axis in the map) and a Y-axis (the vertical axis in the map) in the 2D indoor map.

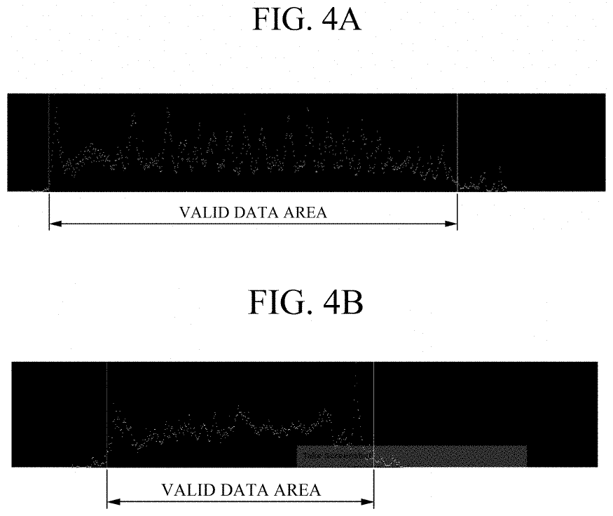

In other words, the computing device 12 may show the distribution of spatial values (values representing whether a corresponding space is empty or occupied by an object) as a histogram along each of the X-axis and the Y-axis in the 2D indoor map. FIGS. 4A and 4B are histograms showing the distribution of spatial values in an X-axis and a Y-axis according to an embodiment of the present disclosure. FIG. 4A shows the distribution of spatial values in the X-axis, and FIG. 4B shows the distribution of spatial values in the Y-axis.

The computing device 12 may detect an area including spatial value data at a preset ratio (e.g., 95%) as a valid data area. In other words, the computing device 12 may detect a section in which 95% of spatial value data is concentrated as a valid data area in FIGS. 4A and 4B.

In each valid data area of FIG. 4A and FIG. 4B, a minimum point is shown in red, and a maximum point is shown in green. As such, a valid data area is detected in a 2D indoor map so that the task of removing noise may be performed only in a valid data area. Consequently, an unnecessary task is prevented, and operation processing speed may be increased.

Meanwhile, it has been described that a valid data area is detected with respect to spatial values in the X-axis and the Y-axis, but a valid data area may also be detected with respect to spatial values in a Z-axis.

In operation 208, the computing device 12 generates an occupancy height map in the valid data area by stacking spatial value histograms in a Z-axis direction (i.e., a height direction) while projecting the 3D indoor map on the 2D XY plane.

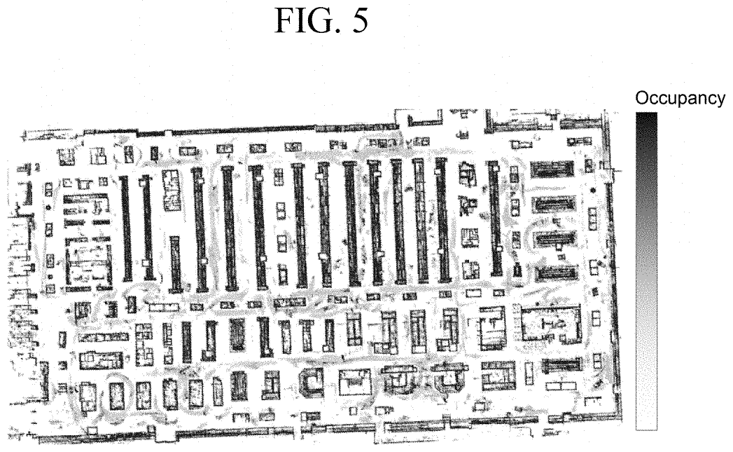

FIG. 5 is an occupancy height map according to an embodiment of the present disclosure. Referring to FIG. 5, when spatial value histograms are stacked in the Z-axis direction while the 3D indoor map is projected on the 2D XY plane, the more spatial value data is stacked, the higher the occupancy (shown as being darker in FIG. 5). Also, the less spatial value data is stacked, the lower the occupancy (shown as being brighter in FIG. 5).

In FIG. 5, parts similar to black are stationary structures, such as walls and racks, and a large amount of spatial value data is stacked (the histogram has a high density) therein. Parts similar to white are empty spaces, and no spatial value data is stacked (the histogram has no density) therein. In parts similar to grey, a moderate amount of spatial value data is stacked by a mobile object (the histogram has an intermediate density). As such, according to the occupancy height map, it is possible to distinguish among stationary structures, such as walls and racks, empty space, noise caused by a mobile object, and the like, indoors.

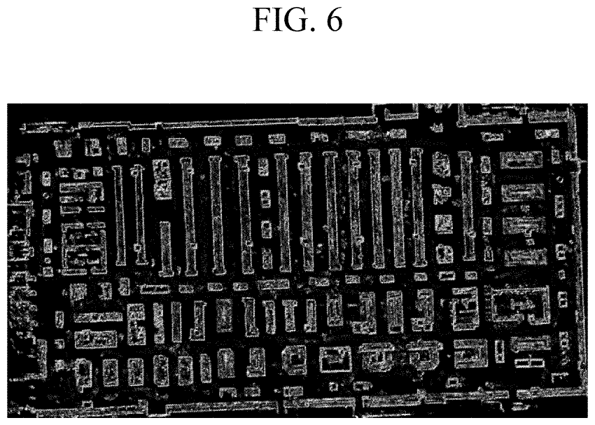

In operation 210, the computing device 12 generates an edge map by applying a filter to the occupancy height map. The computing device 12 may remove noise caused by a mobile object first time by applying a Gaussian filter to the occupancy height map. Then, the computing device 12 may detect edges by applying a Sobel filter to each of the X-axis and the Y-axis to generate an edge map. FIG. 6 is an edge map generated by applying a filter to the occupancy height map according to an embodiment of the present disclosure.

In operation 212, the computing device 12 removes noise caused by a mobile object from the edge map on the basis of an indoor travel path and a scanning path (i.e., a path through which scanning is performed) of the autonomous mobile robot and the edge map.

When the autonomous mobile robot generates the 3D indoor map by scanning the interior while travelling in the interior, the computing device 12 may acquire data of the travel path of the autonomous mobile robot. The computing device 12 may determine a part corresponding to the travel path of the autonomous mobile robot as a travelable area in the occupancy height map. In other words, a path that the robot traveled indoors may be set as a travelable area, and the travelable area may be set as a noise removal area in the occupancy height map. In other words, since a mobile object may also move the path that the robot traveled, the travelable area may be set as an area from which noise caused by a mobile object is removed.

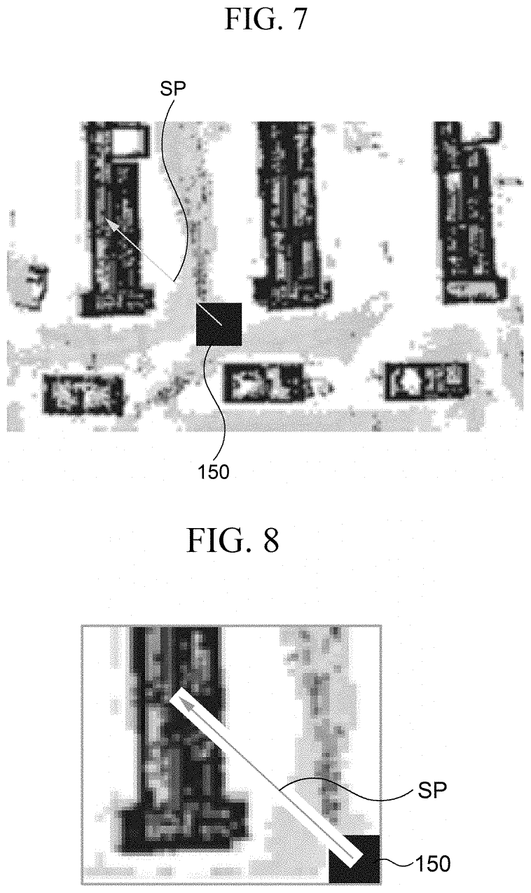

Also, the computing device 12 may remove noise caused by a mobile object using the scanning path of the autonomous mobile robot in the travelable area. FIG. 7 is a view showing a case in which an autonomous mobile robot 150 scans a rack 160 according to an embodiment of the present disclosure. To scan the interior, the autonomous mobile robot 150 emits a laser and receives the emitted laser being reflected by an object. Here, a path through which the laser is emitted may be referred to as a scanning path SP. It has been described that the autonomous mobile robot 150 scans the interior by emitting a laser. However, a scan method is not limited thereto, and the autonomous mobile robot 150 may scan the interior by emitting another type of light beam or a radio wave.

In the occupancy height map, a part of the travelable area corresponding to the scanning path SP is a part that the laser passes through. Therefore, as shown in FIG. 8, noise may be removed from the part of the travelable area corresponding to the scanning path SP. In this case, removal of noise may denote a process of determining a spatial value of the part corresponding to the scanning path SP in the occupancy height map to be void.

Rack parts of the interior have heights, and an empty space may be present according to a height. For example, a rack may have three layers. When there are no objects in the second and third layers, empty spaces are present in the second and third layers. In this case, the laser scanning path SP reaches to the inside of the rack, and when noise is removed, the inside of the rack is also deleted as shown in FIG. 8.

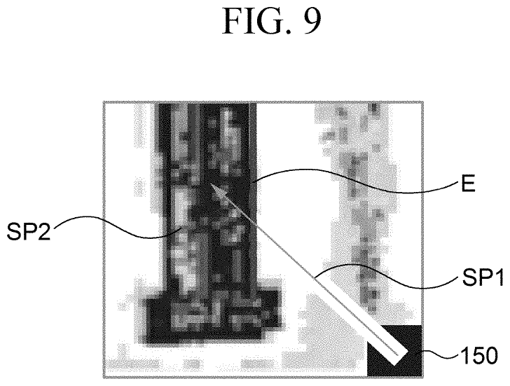

For this reason, according to the embodiment of the present disclosure, noise may be removed from a part SP1 of the scanning path SP extending to an edge E of the rack using the edge map acquired by detecting edges in the occupancy height map as shown in FIG. 9, and noise may not be removed from a part SP2 of the scanning path SP crossing the edge E of the rack. In this way, the computing device 12 may remove noise from a part corresponding to the scanning path SP throughout the travelable area.

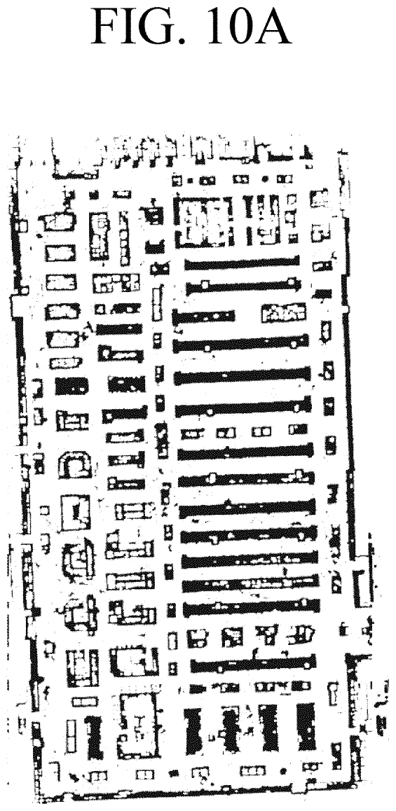

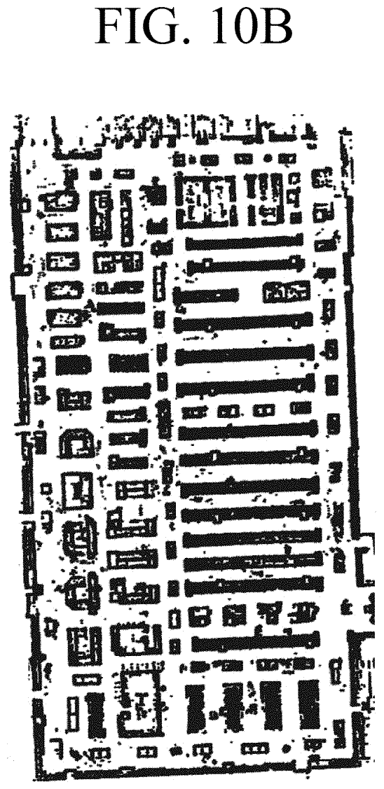

In operation 214, the computing device 12 removes remaining noise from the occupancy height map. In an exemplary embodiment, the computing device 12 may remove remaining noise by applying morphological filtering to the edge map. Specifically, as shown in FIGS. 10A and 10B, the computing device 12 may remove remaining noise by performing an erosion operation (FIG. 10A) and then a dilation operation (FIG. 10B) on the occupancy height map. In other words, the erosion operation may be performed to remove the remaining noise while reducing the occupancy height map in size, and the dilation operation may be performed to expand the occupancy height map to the original size.

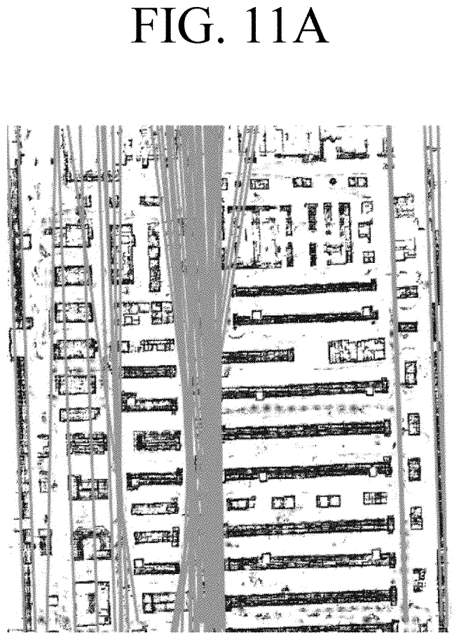

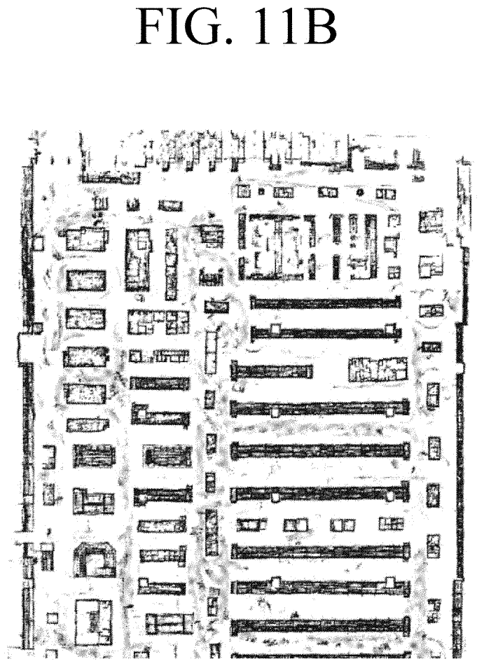

In operation 216, the computing device 12 detects a grade of the occupancy height map and corrects a tilt of the occupancy height map by rotating the occupancy height map by the detected grade. FIGS. 11A and 11B are views showing the occupancy height map of which a tilt is corrected according to an embodiment of the present disclosure.

Referring to FIG. 11A, the computing device 12 may detect a straight line in the occupancy height map. The computing device 12 may detect a straight line (a principal line) in the horizontal direction and the vertical direction in the occupancy height map. The computing device 12 may calculate an inclination (i.e., a grade) of the detected straight line with respect to the X-axis and the Y-axis. Referring to FIG. 11B, the computing device 12 may correct the tilt of the occupancy height map by rotating the occupancy height map by the calculated grade in the opposite direction.

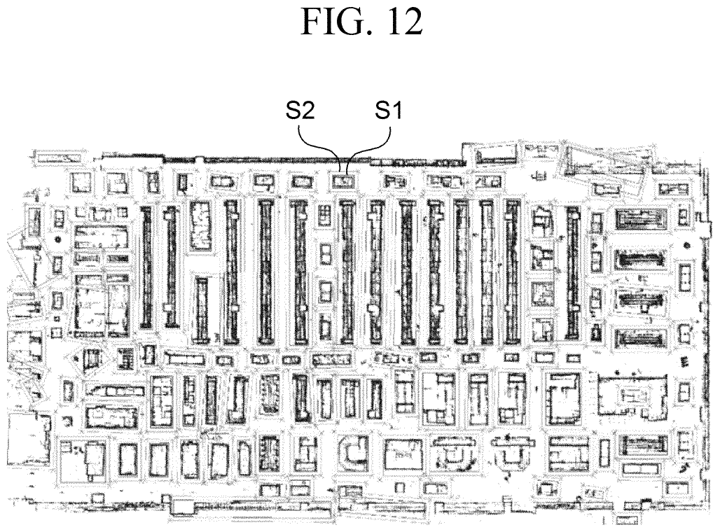

In operation 218, the computing device 12 detects each rack in the occupancy height map and generates a surrounding scan path for each rack. FIG. 12 is a view showing an occupancy height map in which a surrounding scan path is generated for each rack according to an embodiment of the present disclosure.

Specifically, the computing device 12 may detect each rack in the occupancy height map from which noise caused by a mobile object has been removed. In an exemplary embodiment, the computing device 12 may detect each rack in the occupancy height map on the basis of size information of racks (e.g., horizontal and vertical lengths of a rack and a width-to-length ratio of a rack).

Since racks generally have rectangular shapes, the computing device 12 may detect four vertices corresponding to size information of a rack among stationary structures in the occupancy height map and set a rack area 51 which includes four vertices and includes each rack (a blue box in FIG. 12).

The computing device 12 may determine that a stationary structure which has a size exceeding a range preset on the basis of size information of racks (i.e., a stationary structure which is excessively smaller or larger than racks) is not a rack among stationary structures in the occupancy height map.

Subsequently, the computing device 12 may set rack-specific surrounding scan paths S2 on the basis of a distance between the autonomous mobile robot and racks (e.g., 50 cm to 80 cm). In other words, the autonomous mobile robot moves while maintaining a certain distance from each rack, and thus the computing device 12 may set the rack-specific surrounding scan paths S2 by extending four sides of the rack areas 51 by the preset distance. The surrounding scan paths S2 may be paths for the autonomous mobile robot to scan corresponding racks.

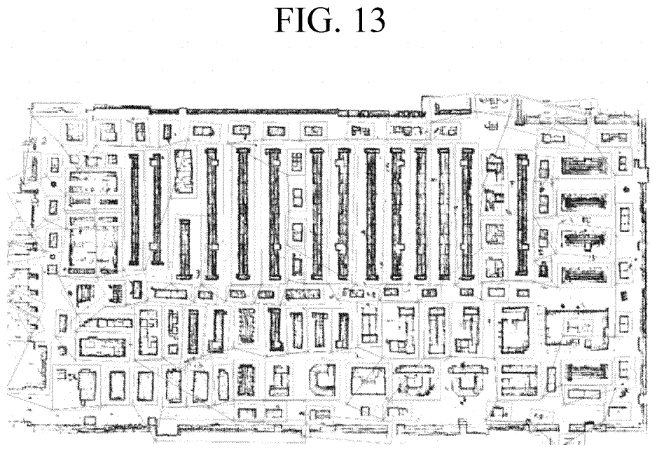

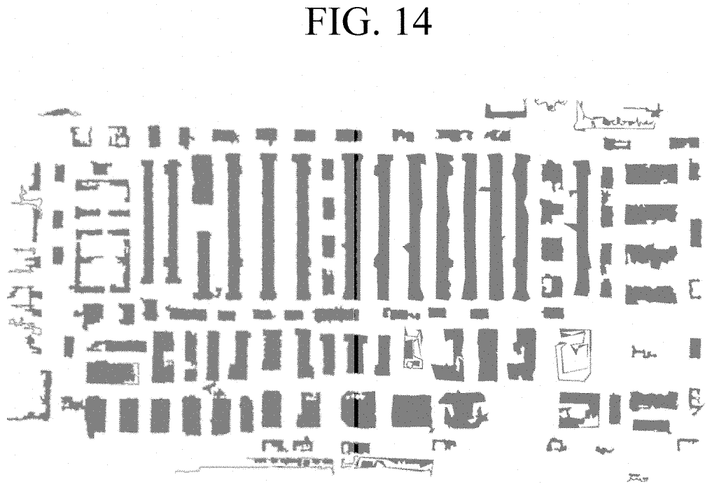

In operation 220, the computing device 12 generates a sequential scan path in the occupancy height map regarding a sequence for scanning racks. In other words, the computing device 12 may generate a sequential scan path for scanning all the racks by visiting each rack, for which a surrounding scan path S2 is generated, only once. In an exemplary embodiment, the computing device 12 may generate a sequential scan path among racks using a travelling salesman problem algorithm. FIG. 13 is a view showing an occupancy height map in which a sequential scan path for each rack is generated according to an embodiment of the present disclosure.

When a current indoor location of the autonomous mobile robot is obtained, the autonomous mobile robot may determine which one of racks it scans first on the basis of the location of the autonomous mobile robot and the sequential scan path among racks.

Meanwhile, in an embodiment of the present disclosure, a computer-aided design (CAD) map of the interior may be generated from the occupancy height map. In general, an indoor CAD map involves a person's manual measurement of the size and the like of each rack. However, when an occupancy height map is used, it is possible to automatically generate a draft of a CAD map while reducing a cost and effort of manual tasks. In this case, a process may be additionally performed to smooth the surface of each rack (e.g., using the Douglas-Peucker algorithm). FIG. 14 is a view showing a CAD map generated from an occupancy height map according to an embodiment of the present disclosure.

According to the embodiment of the present disclosure, an occupancy height map is generated on the basis of a 3D indoor map, and noise caused by a mobile object is removed from the occupancy height map. Consequently, a scan path of an autonomous mobile robot can be automatically generated indoors, and accordingly it is unnecessary to manually input scan paths of the autonomous mobile robot one by one.

Although exemplary embodiments of the present disclosure have been described in detail, it should be understood by those skilled in the art that various modifications can be made to the above-described embodiments without departing from the scope of the present disclosure. Therefore, the scope of the present disclosure is not limited to the described embodiments and should be determined by the following claims and their equivalents.

What is claimed is:

1. A method of generating a scan path of an autonomous mobile robot, which is performed by a computing device including one or more processors and a memory that stores one or more programs executed by the one or more processors, the method comprising:
acquiring a three-dimensional (3D) map of an interior;
generating an occupancy height map by stacking spatial value histograms in a height direction while projecting the 3D map of the interior on a two-dimensional (2D) plane; and
removing noise, which is caused by a mobile object moving in the interior from the occupancy height map.

2. The method of claim 1, wherein the generating of the occupancy height map comprises:
converting the 3D map of the interior into a 2D map by projecting the 3D map on the 2D plane; and
detecting an area including spatial value data at a preset ratio in the 2D map as a valid data area.

3. The method of claim 1, wherein the 3D map of the interior is generated by the autonomous mobile robot scanning the interior while travelling in the interior; and
the removing of the noise caused by the mobile object comprises:
acquiring data of a travel path and a scanning path of the autonomous mobile robot in the interior;
setting a part of the occupancy height map corresponding to the travel path of the autonomous mobile robot as a travelable area; and
removing the noise caused by the mobile object by using the scanning path in the travelable area of the occupancy height map.

4. The method of claim 3, wherein a plurality of racks are installed in the interior; and
the removing of the noise caused by the mobile object comprises:
detecting edges in the occupancy height map; and
removing noise from a part of the scanning path extending to the edges of the racks in the occupancy height map without removing noise from a part of the scanning path crossing the edges of the racks.

5. The method of claim 1, further comprising, after the removing of the noise caused by the mobile object, removing remaining noise from the occupancy height map.

6. The method of claim 1, further comprising:
detecting a grade of the occupancy height map; and
correcting a tilt of the occupancy height map by rotating the occupancy height map by the detected grade.

7. The method of claim 1, further comprising, after the removing of the noise caused by the mobile object, setting a surrounding scan path for each rack in the occupancy height map,
wherein the racks are installed in the interior.

8. The method of claim 7, wherein the setting of the surrounding scan path comprises:
detecting each of the racks in the occupancy height map and setting a rack area including each of the detected racks; and
setting the surrounding scan path for each of the racks by expanding the rack area on the basis of a distance between the autonomous mobile robot and each of the racks.

9. The method of claim 7, further comprising, after the setting of the to surrounding scan path, generating a sequential scan path for scanning each of the racks in the occupancy height map.

10. A computing device comprising:
one or more processors;
a memory; and
one or more programs,
wherein the one or more programs are stored in the memory and executed by the one or more processors, and
the one or more programs comprise:
an instruction for acquiring a three-dimensional (3D) map of an interior:
an instruction for generating an occupancy height map by stacking spatial value histograms in a height direction while projecting the 3D map of the interior on a two-dimensional (2D) plane; and
an instruction for removing noise caused by a mobile object which moves in the interior from the occupancy height map.
